(19) United States
(12) Patent Application Publication
(10) Pub. No.: US 2022/0348775 A1
(43) Pub. Date: Nov. 3, 2022

(54) INORGANIC COATING COMPOSITION CONTAINING FUNCTIONALISED GRAPHENE AS A REPLACEMENT FOR METALLIC PIGMENTS

(71) Applicant: TALGA TECHNOLOGIES LIMITED, Cambridge, Cambridgeshire (GB)

(72) Inventors: Sivasambu BOHM, Huntingdon, Cambridgeshire (GB); Karanveer S. ANEJA, Cambridge, Cambridgeshire (GB); Henegama BOHM, Huntingdon, Cambridgeshire (GB)

(73) Assignee: TALGA TECHNOLOGIES LIMITED, Cambridge, Cambridgeshire (GB)

(21) Appl. No.: 17/621,527

(22) PCT Filed: Jun. 25, 2020
(86) PCT No.: PCT/GB2020/051546

§ 371 Date: Dec. 21, 2021

(30) Foreign Application Priority Data
Jun. 27, 2019 (GB) 1909237.8

(51) Int. Cl. C09D 7/62; C09D 183/04; C09D 7/45; C09D 5/10

(52) U.S. Cl. CPC C09D 7/62; C09D 183/04; C09D 7/45; C09D 5/106; C08K 13/06

(57) ABSTRACT

A coating composition having an inorganic binder, metallic pigments, a filler, and functionalised graphene for at least partially replacing a proportion of the metallic pigments in the coating composition is disclosed.

### TECHNICAL FIELD OF THE INVENTION

The present invention relates to a coating composition containing an inorganic binder, metallic pigments and functionalised graphene for at least partially replacing a proportion of the metallic pigments, to a method of preparing the coating composition, to an article comprising a coating layer formed from the composition, to a method of coating the article with the coating composition and to the use of functionalised graphene as a replacement for metallic pigments in the coating composition.

### BACKGROUND TO THE INVENTION

Zinc silicate coatings are often used on marine vessels and in the marine industry to provide temporary corrosion protection to the underlying substrate, typically steel, during storage and/or heat-intensive fabrication processes such as welding, laser cutting, plasma cutting or oxy-fuel cutting. These temporary coatings are typically referred to as “shop primers” and are normally removed after fabrication. However, in certain instances ship builders prefer not to remove the shop primer after fabrication so that it remains on the underlying substrate, in which case the “permanent” post-primer should exhibit good corrosion resistance and good adhesion to the anti-corrosive coatings that are typically applied by ship builders to extend the lifespan of the coated substrate in use.

Although zinc silicate coatings exhibit good corrosion resistance due to the presence of zinc in the coating, it is often necessary to reduce the zinc content to minimise splashing and the generation of ZnO fumes during welding operations for example. The incorporation of high quantities of zinc is also known to result in brittle coatings being formed which is undesirable since this will reduce the service life of the coating and the coated structure. It is also understood that the service life of structures provided with a zinc silicate coating is limited by the zinc content in the coating and that under normal circumstances reducing the zinc content will reduce the service life of the coated structure. Moreover, since zinc is amphoteric it will corrode preferentially in both acidic and basic environments. As such, the service life of structures provided with a zinc silicate coating comprising zinc may be reduced. In addition, and in the case of water-based zinc silicate primers (shop or pre and post permanent), large quantities of zinc are needed because a proportion of the zinc will react with oxygen to form zinc oxide. This not only increases the cost of producing the coated structure but also limits the effectiveness of these water-based systems.

It is an object of embodiments of the present invention to provide a shop and/or permanent primer that contains reduced quantities of metallic pigments such as zinc. It is also an object of embodiments of the present invention to reduce the metallic pigment content in a shop and/or permanent primer without reducing the corrosion protective and mechanical properties (including adhesion properties) of the primer. It is another object of embodiments of the present invention to provide a shop and/or permanent primer which is able to protect an underlying structure from corrosion for extended periods of time. It is a further object of embodiments of the present invention to provide an eco-friendly, light weight and cost-effective method for producing coated structures.

### SUMMARY OF THE INVENTION

According to a first aspect of the invention there is provided a coating composition comprising:
i. an inorganic binder;
ii. metallic pigments;
iii. a filler; and
iv. functionalised graphene for at least partially replacing a proportion of the metallic pigments in the coating composition.

The introduction of the functionalised graphene into the coating composition enables the content of metallic pigments in the coating composition to be reduced by 50 wt % while improving the corrosion resistant properties and mechanical properties of the coatings thus formed. Moreover, the incorporation of functionalised graphene results in a denser coating network with improved barrier and mechanical properties while simultaneously reducing the overall weight of the coatings thus formed. It has also been found that the coatings formed from the coating composition exhibit good adhesion properties which means they can be used as a “permanent” primer if desired.

The coating composition may comprise:
i. 0.5-10 wt % of the functionalised graphene;
ii. 5-85 wt % of the metallic pigment;
iii. 5-60 wt % of the inorganic binder; and
iv. the filler.

The coating composition may comprise 0.5-10 wt % of the functionalised graphene, while in other embodiments the coating composition may comprise 0.5-5 wt % of the functionalised graphene. In some embodiments the coating composition may comprise 1-2 wt % of the functionalised graphene. With the density of graphene being much lower than that of zinc, fractional amounts of graphene can be used to replace large amounts of zinc.

The coating composition may comprise 5-60 wt % of the inorganic binder. For instance, the inorganic binder content may be 25-55 wt %. In particular, the inorganic binder may comprise a silicate resin or a mixture of silicate resins. For example, the inorganic binder may comprise an alkyl silicate resin or an alkali silicate resin. The alkyl silicate resin may comprise an ethyl silicate resin or a methyl silicate resin. The alkali silicate resin may comprise sodium or potassium, i.e. where pH>7.

The coating composition may comprise 5-85 wt % of the metallic pigment. In particular, the coating composition may comprise 5-50 wt %, 5-40 wt %, 5-30 wt %, 5-20 wt % or 5-10 wt % of the metallic pigment. The metallic pigment may comprise zinc or a zinc alloy, aluminium or an aluminium alloy, magnesium or a magnesium alloy, chromium or chromium alloy, iron oxide or a mixture of one or more of said metallic or conductive metal oxide pigments.

The filler may comprise CaCO₃, talc, mica, titanium dioxide, inert fillers or a mixture thereof. The presence of functionalised graphene in the coating composition means that the coating composition can be modified to contain reduced quantities of metallic pigments such as zinc. However, in order to preserve coating integrity, the filler content should be adjusted to compensate for the quantity of metallic pigment that has been removed/omitted from the coating composition and the presence of functionalised graphene.

According to a second aspect of the invention there is provided a method of producing the coating composition according to the first aspect of the invention, the method comprising the step of reducing the proportion of the metallic pigments in the coating composition by replacing them with the functionalised graphene and the filler.

The method according to the second aspect of the invention may, as appropriate, include any or all features described in relation to the first aspect of the invention.

The functionalised graphene may be prepared by functionalising graphene with a chemical linker, preferably by spraying. Spraying graphene with the chemical linker instead of functionalising graphene in a liquid medium (water or solvent) reduces the amount of chemical linker that is required for functionalising graphene. It is also understood that spraying reduces the risk of graphene nanoplatelets agglomerating which, if subsequently incorporated into a coating composition, would reduce the corrosion protective and mechanical properties of the coatings thus formed.

The chemical linker may be provided in liquid form. If the functionalised graphene is to be incorporated into an aqueous or water-based coating composition, then the chemical linker may be provided in an aqueous or water based solution. On the other hand, if the functionalised graphene is to be incorporated into a solvent based coating composition then the chemical linker may be provided in a solvent based system.

The chemical linker may comprise at least two functional groups. One functional group may be capable of reacting with edge atoms of the graphene. For instance, the functional group for reacting with the edge atoms may comprise an amine group which provides steric hindrance between the graphene platelets which helps to stabilise the system. This chemical linkage also serves to improve graphene wettability and prevents a preferential thermodynamic stacking mode (e.g. ABA, ABB). The second functional group may be capable of reacting with the inorganic binder. The second functional group may comprise an amino, hydroxyl, carboxylic acid or epoxy group.

In some embodiments the chemical linker may comprise an organosilane. In particular, the chemical linker may comprise an aminosilane or an aminoalkoxysilane such as APTES. The organosilane, aminosilane or aminoalkoxysilane may be unhydrolyzed.

The step of functionalising graphene with the chemical linker may be carried out with graphene in a substantially dry condition. Functionalising graphene in this way enables the functionalised graphene to be incorporated as a ‘ready mix’ ingredient in any resin system irrespective of the mixing ratios. It also avoids or at least significantly minimises the use of solvents which means that issues surrounding the handling of solvents and their disposal are avoided. The agglomeration of graphene is known to result in the formation of a galvanic couple with bare metal which can increase the rate of corrosion. By functionalising graphene with the chemical linker, it is able to bond with the inorganic binder, which helps to ensure that the graphene is effectively dispersed and does not agglomerate in the inorganic binder. Moreover, since functionalisation is carried out with graphene in a substantially dry condition, rather than it being dispersed in a solvent, reduced quantities of the chemical linker are needed for functionalising graphene which helps to reduce costs. The graphene may be functionalised with 0.1-10 wt % of the chemical linker.

The step of functionalising graphene may comprise bringing a wetting agent into contact with the graphene. The graphene may be brought into contact with 0.1-5 wt % of the wetting agent.

The step of functionalising graphene may comprise bringing a dispersing agent into contact with the graphene. The graphene may be brought into contact with 0.1-10 wt % of the dispersing agent.

In some embodiments functionalising graphene may comprise the step of first bringing the wetting agent into contact with the graphene and then bringing the dispersing agent into contact with the graphene. The addition of the wetting and/or dispersing agent at this stage helps to ensure good wettability and dispersion of graphene during functionalisation and when the functionalised graphene is incorporated into the inorganic binder.

The wetting agent and/or dispersing agent may be solvent based or water based. The wetting and/or dispersing agent may comprise any of the following functional groups: —NH₂, —OH, —O═C—NH, —(NH₂)₂ and —(NH₂)₃. It has been found that wetting and/or dispersing agents comprising amino, hydroxyl, carboamide, diamine and triamine functional groups are very suitable for reacting with the edge electrons of graphene and as a result, improvements in corrosion protection can be obtained even when coatings contain reduced quantities of metallic pigments.

Examples of dispersing agents that may be used in accordance with the present invention include water based dispersing agents such as DisperBYK2010, DisperBYK2012, Disperbyk 2025, Anti terra 250, DisperBYK 190, Disperbyk 199, BYK093, BYK 2025, BYK 154, BYK1640, and CARBOWET® GA-100 (Evonik) and solvent based dispersing agents such as BYK9077. A preferred dispersing agent for a solvent based system is an alkylammonium salt of a high molecular-weight copolymer such as BYK 9076.

The wetting agent may comprise a polyether-modified poly-siloxane or modified polyacrylate, e.g. BYK 333 and BYK 3550.

The graphene may be oxide-free or “pristine” graphene, partially oxidised graphene or a limited oxygen content (<5%) graphene. These do not include graphene that has been reduced from graphene oxide since residual oxide will inevitably remain following the reduction step. The use of oxide-free graphene instead of graphene oxide (GO) or reduced graphene oxide (RGO) is understood to improve the corrosion protective and mechanical properties of coatings in which it is incorporated. Moreover, and relative to GO and RGO, it is believed that the incorporation of functionalised oxide-free graphene into coatings enables greater quantities of metallic pigments to be replaced.

The graphene may comprise graphene nanoplatelets. The graphene nanoplatelets may be provided in powder form.

The functionalisation of graphene may be carried out in air or under an inert atmosphere. If functionalisation is carried out under an inert atmosphere, the inert atmosphere ensures that pristine graphene does not become oxidised or at least minimises the risk of oxidation which could be detrimental to the corrosion protective properties of coatings comprising functionalised graphene. This may be dersible if using air sensitive/extremely reactive functionalising agents. If partially oxidised graphene or limited oxygen graphene is used, functionalising under an inert atmosphere helps to ensure that the oxygen content does not exceed 5%.

In some embodiments the method may comprise the steps of forming a pre-mix composition containing functionalised graphene, metallic pigments and filler and then combining the pre-mix composition with the inorganic binder. Alternatively, the method may comprise the steps of forming a pre-mix composition containing functionalised graphene, metallic pigments and filler, pre-dispersing the pre-mix composition in a solvent and then combining the pre-dispersed pre-mix composition with the inorganic binder.

The functionalised graphene may be dried. The functionalised graphene may be dried under ambient conditions or it may be subjected to a heat treatment. The heat treatment may not exceed a temperature of 50° C. In some embodiments the step of drying the functionalised graphene may be carried out under an inert atmosphere, e.g. under a nitrogen atmosphere. This helps prevent or at least reduces the risk of the graphene becoming oxidised, especially if the functionalised graphene is being subjected to the heat treatment.

The step of functionalising graphene may be carried out in a fluidised bed, in a dry/wet mill or in a high shear/speed mechanical mixer.

According to a third aspect of the invention there is provided a coated article, wherein the article comprises an inorganic coating layer formed from the coating composition according to the first aspect of the invention or produced by the method according to the second aspect of the invention.

The coated article according to the third aspect of the invention may, as appropriate, include any or all features described in relation to the first and second aspects of the invention.

In some embodiments the coating layer has a dry film thickness of 1-150 microns. The coating may be a shop primer having a dry film thickness of 1-30 microns or a permanent primer having a dry film thickness of 1-150 microns.

The article may comprise a metal substrate, an automotive vehicle, an aircraft, an electrical or domestic appliance, an offshore structure, a marine vessel or a dry dock.

According to a fourth aspect of the invention there is provided a method of producing a coated article, wherein the method comprises the step of applying the coating composition according to the first aspect of the invention or produced according to the method of the second aspect of the invention on the surface of the article.

The method according to the fourth aspect of the invention may, as appropriate, include any or all features described in relation to the first, second and third aspects of the invention.

According to a fifth aspect of the invention there is provided the use of functionalised graphene produced according to the second aspect of the invention as a replacement for metallic pigments in a coating layer.

The use according to the fifth aspect of the invention may, as appropriate, include any or all features described in relation to the second aspect of the invention.

According to a sixth aspect of the invention there is provided a coating composition comprising:
i. an inorganic binder;
ii. metallic pigments;
iii. a filler; and

surface-modified graphene for at least partially replacing a proportion of the metallic pigments in the coating composition.

The coating composition according to the sixth aspect of the invention may include any or all features described in relation to the first aspect of the invention.

According to a seventh aspect of the invention there is provided a method of producing the coating composition according to the sixth aspect of the invention, the method comprising the step of reducing the proportion of the metallic pigments in the coating composition by replacing them with the surface-modified graphene and the filler. The method according to the seventh aspect of the invention may, as appropriate, include any or all features described in relation to the first and second aspects of the invention.

According to an eighth aspect of the invention there is provided a coated article, wherein the article comprises an inorganic coating layer formed from the coating composition according to the sixth aspect of the invention or produced by the method according to the seventh aspect of the invention.

The coated article according to the eighth aspect of the invention may, as appropriate, include any or all features described in relation to the first, second and third aspects of the invention.

According to a ninth aspect of the invention there is provided a method of producing a coated article, wherein the method comprises the step of applying the coating composition according to the sixth aspect of the invention or produced according to the method of the seventh aspect of the invention on the surface of the article.

The method according to the ninth aspect of the invention may, as appropriate, include any or all features described in relation to the first, second, third and fourth aspects of the invention.

According to a tenth aspect of the invention there is provided the use of surface-modified graphene according to the sixth aspect of the invention or produced according to the seventh aspect of the invention as a replacement for metallic pigments in a coating layer.

The use according to the fifth aspect of the invention may, as appropriate, include any or all features described in relation to the first and second aspects of the invention.

### DETAILED DESCRIPTION OF THE INVENTION

In order that the invention may be more clearly understood one or more embodiments thereof will now be described, by way of example only, with reference to the accompanying drawings, of which:

FIG. 1 shows a reaction scheme for producing a zinc silicate coating according to the prior art;

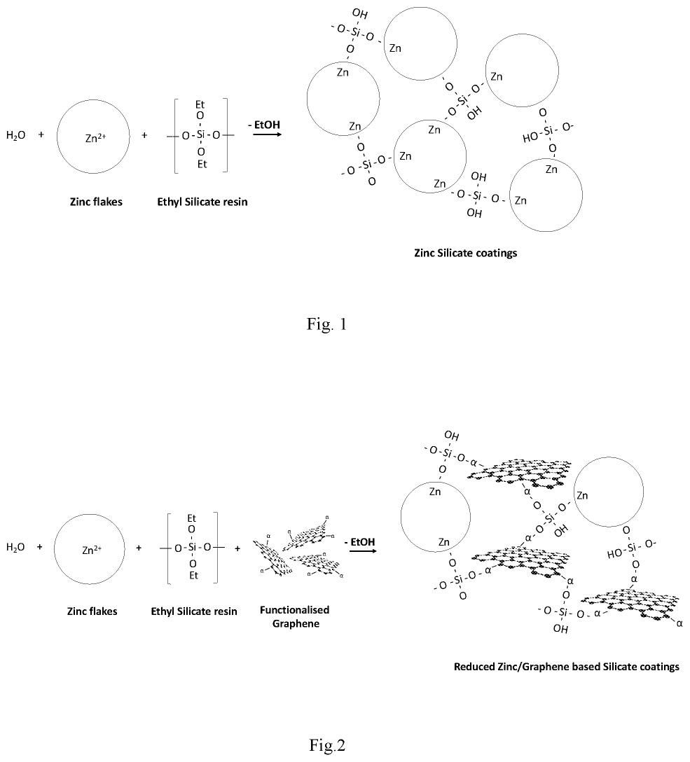

FIG. 2 shows a reaction scheme in accordance with the present invention for producing a silicate coating containing functionalised graphene and reduced quantities of zinc;

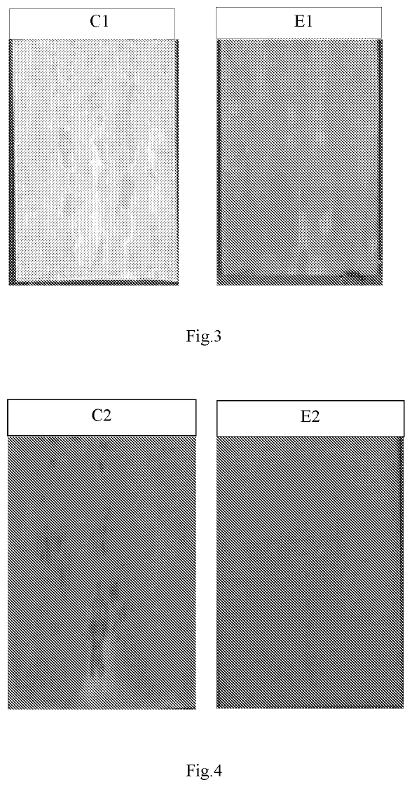

FIG. 3 shows some salt spray test results after 1500 hours for zinc-containing silicate coatings with and without functionalised graphene;

FIG. 4 shows some further salt spray test results after 1500 hours for zinc-containing silicate coatings with and without functionalised graphene;
and

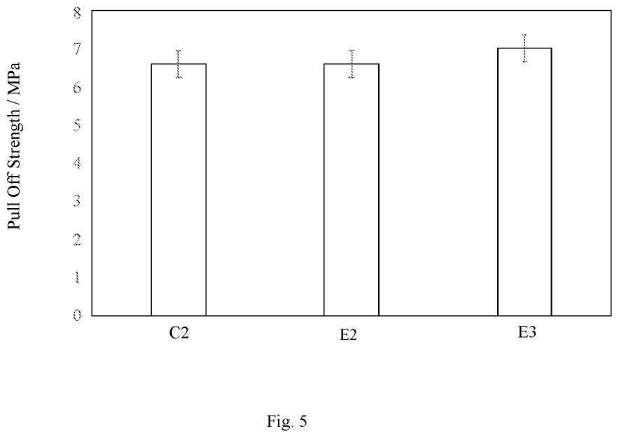

FIG. 5 shows a graph of pull off strength for three different zinc-containing silicate coatings C2, E2 and E3.

A reaction scheme for producing a zinc silicate coating according to the prior art is shown in FIG. 1. As alluded to hereinbefore, silicate coatings with a high zinc content typically exhibit good corrosion protection, but tend to suffer from a reduced service life, particularly in respect of silicate/zinc coatings where the service life is limited by the zinc content in the coating.

FIG. 2 depicts an improved reaction scheme to that depicted in FIG. 1. The reaction scheme shown in FIG. 2 involves mixing functionalised graphene with zinc and an ethyl silicate resin to produce a zinc silicate coating with functionalised graphene. The incorporation of functionalised graphene into the inorganic coating network enables the content of zinc pigments to be reduced without any detrimental effect on corrosion protection. FIG. 2 additionally shows that the functionalised graphene is chemically linked to the silicate. This not only increases the barrier protection properties of zinc silicate coatings, it also results in a denser and stronger inorganic coating network being formed with improved mechanical properties, all of which serve to minimise the service life issues experienced by prior art zinc silicate coating systems (as depicted in FIG. 1) whilst offering other benefits such as reduced manufacturing costs, reduced coating weight due to the reduced zinc content and effective dispersion of graphene throughout the coating network.

One embodiment of such an improved reaction scheme which includes functionalised graphene preparation and subsequent coating composition preparation components is described in further detail below.

Functionalised Graphene Preparation Pristine, oxide-free graphene nanoplatelets (GNP) are functionalised by introducing GNP (94 wt %) into a LODIGE Ploughshare® Mixer in the form of a powder. The GNP powder is in a substantially dry condition and free from moisture. The mixer is then activated and as the GNP powder starts to atomise or deagglomerate it is sprayed with BYK 9076 dispersing agent (2 wt %) and then with unhydrolyzed APTES (2 wt %) to produce functionalised GNP powder. Following functionalisation, the functionalised GNP powder may be heated to help drive off any residual liquid that may be present. However, the functionalised GNP powder should not be heated to a temperature above 50° C. to avoid premature cross-linking during storage. The heat treatment is carried out within the mixer in air, although it can also be carried outunder a nitrogen atmosphere to minimise the risk of the functionalised pristine GNPs becoming oxidised.

### Coating Composition Preparation

The functionalised GNP powder is mixed with the other powder components of the coating composition, namely zinc and CaCO₃. These powder components are then mixed with ethyl polysilicate (Dynasilan 40) in water and this mixture is stirred for 5 minutes at 2000 RPM. The mixture is then spray-coated onto a steel substrate. The coated steel substrate is then cured at room temperature (i.e. 1.5 hours for through-drying and 7 days for complete curing) to form a coating having a dry film thickness ranging between 20-60 microns. Exemplary compositions E1-E2 are shown in Table 1 below together with comparative examples C1 and C2.

The E1-E2 coatings were prepared in accordance with the above described methods. Comparative examples C1 and C2 are commercially available zinc based silicate coating compositions, namely Pre-fab primer “Hempel ZS 15890” (C1) and Post-fab primer “Jotun Resist 78” (C2).

TABLE 1

| | | Functionalized | | Coating Thickness |
|---|---|---|---|---|
| | Zinc | Graphene | Ethyl Silicate | (Microns) |
| C1 | 20% | 0 | 40% | 20 microns |
| C2 | 60% | 0 | 26% | 60 microns |
| E1 | 10% | 1.0% | 56% | 20 microns |
| E2 | 30% | 1.7% | 44% | 60 microns |

### Salt Spray Test

The coated substrates C1 and E1 were subjected to a salt spray test (ASTM B117) for 500 hours to determine the corrosion resistant properties of the respective coatings. The results of the salt spray test (shown in FIG. 3) show that the E1 coating exhibits superior corrosion resistance relative to the C1 coating despite the E1 coating containing 50% less zinc and having a reduced layer thickness.

The coated substrates C2 and E2 were also subjected to a salt spray test (ASTM B117) for 750 hours to determine the corrosion resistant properties of the respective coatings. The results of this salt spray test (shown in FIG. 4) show that the E2 coating also exhibits superior corrosion resistance relative to the C2 coating despite the E2 coating containing 50% less zinc.

### Adhesion Test

A pull off adhesion test was also carried out in accordance with ASTM G 4541. Experiments were carried out to investigate the adhesion strength of the C2 and E2 coatings. A further test was carried out to investigate the adhesion strength of a further coating (E3) which was prepared in the same manner as the E2 coating except that it contained 3 wt % of functionalised graphene. As shown in FIG. 5, the pull off strength of the commercially available coating C2 is comparable to that of the E2 coating. However, FIG. 5 also shows that increasing the content of functionalised graphene in the silicate coating (i.e. E3) enables improvements in adhesion strength to be obtained relative to both the C2 and E2 coatings.

By way of the improved reaction scheme as depicted in FIG. 2, the present invention enables the content of metallic pigments in a coating (particularly of zinc) to be reduced while providing enhanced corrosion resistance/protection and mechanical performance. Furthermore, reducing the metallic content also facilitates a number of additional benefits including improved environmental sustainability (i.e. metallic pigments sacrificially result in corrosion products which can be toxic to marine environments, one reason why zinc rich silicates are less preferred on underwater parts of vessels), enhanced lifetime (i.e. since metallic pigments would eventually corrode while graphene would remain inert) and potential realization of coating thickness/weight/cost reductions. Still further, other potential benefits of a coating composition produced by way of the improved reaction scheme may include enhancement of coating adhesion due to graphene reinforcement and denser crosslinking and improvements in impact and abrasion resistance.

The one or more embodiments are described above by way of example only.

Many variations are possible without departing from the scope of protection afforded by the appended claims.

1: A coating composition comprising:
i. an inorganic binder;
ii. metallic pigments;
iii. a filler; and
iv. functionalised graphene for at least partially replacing a proportion of the metallic pigments in the coating composition.

2: The coating composition according to claim 1, wherein the composition comprises:
i. 0.5-10 wt % of the functionalised graphene;
ii. 5-90 wt % of the metallic pigment;
iii. 5-50 wt % of the inorganic binder; and
iv. the filler.

3: The coating composition according to claim 1, wherein the inorganic binder comprises a silicate resin.

4: The coating composition according to claim 1, wherein the inorganic binder comprises an alkyl silicate resin.

5: The coating composition according to claim 1, wherein the metallic pigment comprises zinc or a zinc alloy, aluminium or an aluminium alloy, magnesium or a magnesium alloy, iron oxide or a mixture of one or more of said metallic or conductive metal oxide pigments.

6. (canceled)

7: A method of producing a coating composition according to claim 1, the method comprising the step of reducing the proportion of the metallic pigments in the coating composition by replacing them with the functionalised graphene and the filler.

8: The method according to claim 7, wherein the functionalised graphene is prepared by functionalising the graphene with a chemical linker, preferably by spraying.

9: The method according to claim 8, wherein functionalising graphene with the chemical linker is carried out with the graphene in a substantially dry condition.

10: The method according to claim 8, wherein the graphene is functionalised with 0.1-10 wt % of the chemical linker.

11: The method according to claim 8, wherein functionalising graphene comprises the step of spraying the graphene with a wetting agent.

12: The method according to claim 11, wherein the graphene is sprayed with 0.1-5 wt % of the wetting agent.

13: The method according to claim 8, wherein functionalising graphene comprises the step of spraying the graphene with a dispersing agent.

14: The method according to claim 13, wherein the graphene is sprayed with 0.1-10 wt % of the dispersing agent.

15: The method according to claim 8, wherein the functionalising graphene comprises the step of first spraying the graphene with the wetting agent and then spraying the graphene with the dispersing agent.

16: The method according to claim 7, wherein the graphene is oxide-free, partially oxidised graphene or a limited oxygen content (<5%) graphene.

17. (canceled)

18: The method according to claim 8, wherein the chemical linker comprises an organosilane.

19: The method according to claim 7, wherein the method comprises the steps of forming a pre-mix composition containing the functionalised graphene, the metallic pigments and the filler and then combining the pre-mix composition with the inorganic binder.

20: The method according to claim 7, wherein the method comprises the steps of forming a pre-mix composition containing the functionalised graphene, the metallic pigments and the filler, pre-dispersing the pre-mix composition in a solvent and then combining the pre-dispersed pre-mix composition with the inorganic binder.

21: A coated article, wherein the article comprises an inorganic coating layer formed from the coating composition according to claim 1.

22. (canceled)

23: The coated article according to claim 21, wherein the article comprises a metal substrate, an automotive vehicle, an aircraft, an electrical or domestic appliance, an offshore structure, a marine vessel or a dry dock.

24-25. (canceled)
